(19) United States
(12) Patent Application Publication
(10) Pub. No.: US 2016/0071210 A1
(43) Pub. Date: Mar. 10, 2016

(54) DYNAMIC RISK-RESPONSIVE BOND LADDER

(71) Applicant: BANK OF AMERICA CORPORATION, Charlotte, NC (US)

(72) Inventor: Steven K. Stearns, Fairfield, CT (US)

(73) Assignee: BANK OF AMERICA CORPORATION

(21) Appl. No.: 14/477,662

(22) Filed: Sep. 4, 2014

(51) Int. Cl. G06Q 40/06

(52) U.S. Cl. CPC G06Q 40/06

(57) ABSTRACT

Embodiments of the invention relate to systems, methods, and computer program products for monitoring financial risk indicators to provide a composite financial risk indicator and, based on the composite financial risk indicator, determining the number of years for which financial investors in distribution mode should have self-liquidating assets available (i.e., the number of rungs on a bond ladder) to insure that cash flow needs are met in future years regardless of the risk present in the financial markets. In response to determining the number of years for which the investors should have self-liquidating assets, the financial portfolios of the investors are automatically adjusted to provide for self-liquidating assets for each of the determined number of years (i.e., self-liquidating assets are bought or sold).

### FIELD

In general, embodiments of the invention relate to financial management, systems, apparatus and computer program products for marketing financial institution channels and, more particularly, in response to determining a composite financial risk indicator, automatically determining the number of years for which financial investors in distribution mode (e.g., during retirement) should have self-liquidating assets available and making appropriate portfolio adjustments (i.e., purchasing or selling self-liquidating assets) to insure that cash flow needs are met in future years regardless of the risk present in the financial markets.

### BACKGROUND

Dollar cost averaging (DCA) is a technique of buying a fixed dollar amount of a particular investment (e.g., stock fund or the like) on a regular schedule, such as monthly, regardless of the share price. More shares are purchased when prices are low, and fewer shares are bought when prices are high. Due to volatility in the market for the investment, over time the average share cost of the investment is below the average share price of the investment. In this regard, volatility in the market works in the investor's favor when the investor is in the accumulation phase of investment.

In contrast, once an investor retires and the investment portfolio enters the distribution phase, the investor's budget and mandatory distribution requirements will typically result in a constant, regularly scheduled, distribution amount, such as a monthly distribution amount. When share prices are high fewer shares need to be liquidated to provide for the monthly distribution amount, however; when share prices are low more shares need to be liquidated to provide for the monthly distribution amount. Thus, during the distribution phase, the same dollar cost averaging works against the investor and high volatility in the market during the distribution periods can severely impact an investor's financial portfolio.

From a cash sourcing perspective, the investor needs to have an accessible supply of cash during period of high market volatility, such as during a period when markets undergo a significant market correction, to insure against having to sell high volume of shares when the markets are down.

Therefore, a need exists to develop systems, methods and the like which monitor financial risk such that when financial risk indicates that a significant market correction may be forthcoming, more shares from a financial portfolio can be sold in advance of the significant market correction and the proceeds of such sales can be used to accommodate the investor's cash flow needs (i.e., provide the monthly distribution amounts) during the period of significant market correction. As such, the investor is prevented from having to sell shares when the market is down. In addition, a need exists to develop systems, methods and the like which monitor financial risk such that when the financial risk indicates stability in the markets (i.e., no significant market correction is forthcoming or market recovery is imminent), less immediate cash inventory is needed in the future and previously liquidated or ready-liquidating assets can be re-invested in more profitable investments.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for monitoring financial risk indicators to provide a composite financial risk indicator and, based on the composite financial risk indicator, determining the number of years for which financial investors in distribution mode (e.g., during retirement) should have self-liquidating assets available to insure that cash flow needs are met in future years regardless of the risk present in the financial markets. In response to determining the number of years for which the investors should have self-liquidating assets, the financial portfolios of the investors are automatically adjusted to provide for self-liquidating assets for each of the determined number of years. The self-liquidating assets (e.g., bonds or the like) provided for in a year are approximately equal in value to an annual distribution need/requirement of each individual investor offset by an anticipated income from an associated financial portfolio over the future time period.

In this regard, the present invention provides for an automated dynamic bond ladder in which the number of rungs on the bond ladder (i.e., the number of years investors should have self-liquidating assets available) are adjusted in response to changes in financial risk and the size of the rungs on the bond ladder (i.e., the approximate value of the self-liquidating assets needed for each of the determined number of years) are identified for each individual investor based on the cash flow needs and/or requirements of the investor and the anticipated investment income from the investor's portfolio during the future year.

An apparatus for managing the distribution of investment portfolios defines first embodiments of the invention. The apparatus includes a computing platform including a memory and at least one processor in communication with the memory. The apparatus further includes an investment distribution management module that is stored in the memory and executable by the processor. The module is configured to continuously monitor a plurality of financial risk factors to determine a composite financial risk indicator and, based on the composite financial risk indicator, determine a number of future time periods (e.g., calendar years) for which investors having a financial portfolio in distribution mode should have self-liquidating assets to insure against the financial risk. In addition, the module is configured to, in response to determining the number of future time periods, automatically adjust the financial portfolios of the investors to provide for self-liquidating assets for each of the determined number of future time periods. The self-liquidating assets (e.g., bonds or the like that mature in the future time period) provided for in a future time period are approximately equal in value to a distribution need or requirement of each individual investor for the future time period offset by an anticipated income from an associated financial portfolio over the future time period.

In specific embodiments of the apparatus, the investment distribution management module is further configured to, based on the composite financial risk indicator indicating increased financial risk, add one or more future time periods to a current number of future time periods for which the investors should have self-liquidating assets. In such embodiments of the apparatus, the investment distribution management module is further configured to, in response to adding the one or more future time periods, automatically adjust the financial portfolios of the investors by using financial portfolio investment funds to purchase self-liquidating assets for each of the one or more future time periods.

In other specific embodiments of the apparatus, the investment distribution management module is further configured to, based on the composite financial risk indicator indicating decreased financial risk, subtract one or more future time periods from a current number of future time periods for which the investors should have self-liquidating assets. In such embodiments of the apparatus, the investment distribution management module is further configured to, in response to subtracting the one or more future time periods, automatically adjust the financial portfolios of the investors by selling-off self-liquidating assets previously purchased for the one or more future time periods.

It should be noted that in specific embodiments of the apparatus, the investment distribution management module is configured such that a minimum threshold of future time periods are implemented, wherein investors always have self-liquidating assets available for the minimum threshold future time period (e.g., three years). In this regard, if the composite financial risk indicators indicates a predetermined level of increased financial risk, time periods beyond the minimum threshold may be added (e.g., years in addition to the minimum three years) and if the composite financial risk indicators indicates a predetermined level of decreased financial risk, time periods may be subtracted but may not fall below the minimum threshold (e.g., the number of years mat not fall below the three year minimum).

A method for managing financial portfolio distribution defines second embodiments of the invention. The method includes continuously monitoring a plurality of financial risk factors to determine a composite financial risk indicator and, based on the composite financial risk indicator, determining a number of future calendar years for which investors having a financial portfolio in distribution mode should have self-liquidating assets. The method further includes adjusting the financial portfolios of the investors to provide for self-liquidating assets for each of the determined number of future calendar years. The self-liquidating assets provided for in a future calendar year are approximately equal in value to an annual distribution need of each individual investor minus an anticipated income from an associated financial portfolio during the future calendar year.

In specific embodiments of the method, determining the number of future calendar years further includes, based on the composite financial risk indicator indicating increased financial risk, adding one or more future calendar years to a current number of future calendar years for which the investors should have self-liquidating assets. In such embodiments of the method, adjusting the financial portfolios further includes, in response to adding the one or more future calendar years, automatically adjusting the financial portfolios of the investors by using financial portfolio investment funds to purchase self-liquidating assets for each of the one or more future calendar years.

In other specific embodiments of the method, determining the number of future calendar years further includes, based on the composite financial risk indicator indicating decreased financial risk, subtracting one or more future calendar years from a current number of future calendar years for which the investors should have self-liquidating assets. In such embodiments of the method, adjusting the financial portfolios further includes, in response to subtracting the one or more future time periods, automatically adjusting the financial portfolios of the investors by selling-off self-liquidating assets previously purchased for the one or more future time periods.

In further specific embodiments the method includes determining, for each investor, an approximate value of the self-liquidating assets needed for a future calendar year based on the annual distribution need of each individual investor and the anticipated income from an associated financial portfolio during the future calendar year. In such embodiments of the method, the annual distribution need of each investor takes into account mandatory distributions from predetermined accounts (e.g., individual retirement account (IRA) and the like) based on investor age.

A computer program product including a non-transitory computer-readable medium defines third embodiments of the invention. The computer-readable medium includes a first set of codes for causing a computer to continuously monitor a plurality of financial risk factors to determine a composite financial risk indicator. In addition, the computer-readable medium includes a second set of codes for causing a computer to, based on the composite financial risk indicator, determine a number of future time periods for which investors having a financial portfolio in distribution mode should have self-liquidating assets. Additionally the computer-readable medium includes a third set of codes for causing a computer to adjust the financial portfolios of the investors to provide for self-liquidating assets for each of the determined number of future time periods. The self-liquidating assets provided for in a future time period are approximately equal in value to a distribution need of each individual investor for the future time period minus an anticipated income from an associated financial portfolio over the future time period.

Thus, further details are provided below for systems, apparatus, methods and computer program products for providing an automated and dynamic bond ladder to investor's during the distribution phase of a financial portfolio. The automated and dynamic bond ladder is provided for by monitoring financial risk indicators to provide a composite financial risk indicator and, based on the composite financial risk indicator, determining the number of years (i.e., rungs on the bond ladder) for which investors should have self-liquidating assets (e.g., bonds) available to insure that cash flow needs are met in future distribution years regardless of the risk present in the financial markets. In response to determining the number of years for which the investors should have self-liquidating assets, the financial portfolios of the investors are automatically adjusted to provide for self-liquidating assets for each of the determined number of years (e.g., bonds are purchased or sold).

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of an apparatus configured to manage distribution of a financial portfolio through implementation of an automated and dynamic risk-responsive bond ladder, in accordance with embodiments of the present invention;

FIG. 2 is a block diagram of a more detailed apparatus configured to manage distribution of a financial portfolio through implementation of an automated and dynamic risk-responsive bond ladder, in accordance with embodiments of the present invention;

FIG. 3 is a flow diagram of a method for managing distribution of a financial portfolio through implementation of an automated and dynamic risk-responsive bond ladder, in accordance with embodiments of the present invention; and

FIG. 4 is schematic diagram of a system for managing distribution of a financial portfolio through implementation of an automated and dynamic risk-responsive bond ladder, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention relate to systems, apparatus, methods, and computer program products for automatically determining the number of future time periods (e.g., calendar years) for which investors, currently in distribution mode, should have self-liquidating assets (e.g., target maturity bond investments) in their financial portfolios to insure cash flow during a down market. The number of future time periods is determined based on continuously assessing various different risk factors to result in a cumulative financial risk indicator, which indicates the potential for future volatility in the markets. If the cumulative financial risk indicator indicates that the market has higher potential for volatility (i.e., higher risk), future time periods for which self-liquidating assets should be held may be added to the current number of time periods and, as such, self-liquidating assets which mature in the future time periods (e.g., future calendar years) are automatically purchased for investor portfolios. Conversely, if the cumulative risk indicator indicates that the market has lower potential for volatility (i.e., lower risk), future time periods for which self-liquidating assets should be held may be subtracted from the current number of time periods and, as such, self-liquidating assets currently in investor's portfolios which mature in the future time periods being subtracted are automatically sold and the proceeds re-invested accordingly.

The automated nature of the present invention, whereby the number of years for which distribution-phase investors should have self-liquidating assets in their financial portfolios is automatically determined and, in response to changes in the number of years, adjustments (i.e., the buying and selling of self-liquidating assets) in the portfolios occur automatically, is highly beneficial to the financial advisor. In this regard, financial advisors benefit from systems and methods that are advantageously scalable; since the determination of the number of years for which self-liquidating assets should be held and the adjustments to financial portfolios is applicable to most, if not all, of the financial investor's clients. Such scalability lends itself to quality control; making certain that no clients are overlooked in terms of having liquid (or readily liquefiable) assets in their portfolios during a down market period. Moreover, the automated and scalable nature of the invention means that financial advisors no longer have to individually and manually insure that each client has enough cash available in their portfolios during a down market to preclude having to sell assets when their value is down.

From the investor perspective, the present invention insures that the client has the appropriate amount of cash flow in the future to guard against fluctuations and uncertainty in the markets that might otherwise result in the investor having to sell assets when the market is down. Further, by continuously assessing the number of years for which self-liquidating assets should be held and, in response, modifying portfolios in accordance with a client's cash flow needs and/or mandates, the present invention insures that the client has the right amount allocated to self-liquidating assets to meet, but not exceed or fall short of, future cash flow needs.

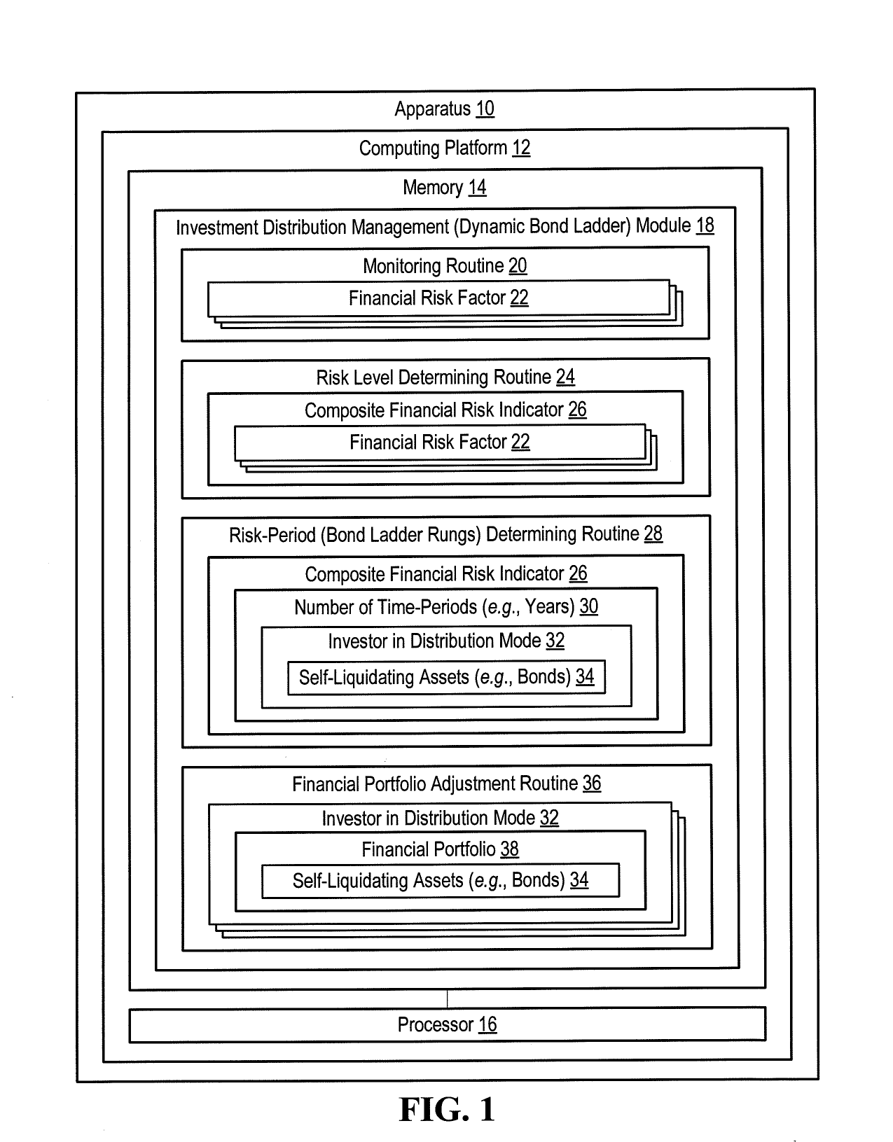

FIG. 1 provides a high level schematic diagram of an apparatus 10 configured for managing distribution of a financial portfolio through implementation of an automated and dynamic risk-responsive bond ladder, in accordance with embodiments of the present invention. The apparatus 10 includes a computing platform 12 having and a memory 14 and at least one processor 16 that is in communication with the memory. The memory 14 of apparatus 10 stores investment distribution management module 18, otherwise referred to herein as dynamic bond ladder module 18, which is configured to automatically manage acquisition and divestment of self-liquidating assets, such as target maturity bonds or the like, in a financial portfolio that is distribution phase/mode (e.g., during an investor's retirement) to insure that investor has adequate cash flow during downturns in the financial markets.

Investment distribution management module 18 (or another module working in concert with investment distribution management module 18) implements a financial risk monitoring routine 20 that is configured to continuously monitor a plurality of financial risk factors 22 (i.e., economic indicators and predictors). In specific embodiments of the invention, upwards of 300 different risk factors 22, which serve as lead indicators of financial risk, may be monitored on a continuous basis. In addition, the investment distribution management module (or another module working in concert with investment distribution management module 18) implements risk level determining routine 24 that is configured to determine a dynamic and cumulative financial risk indicator 26 based on the financial risk factors 22. The financial risk indicator 26 provides an indication of the risk (i.e., stress) present and/or anticipated in financial markets. In the event that the financial risk indicator 26 indicates a predetermined level of risk, it is in the investors best interest to hold more self-liquidating assets, such as target maturity bonds in their portfolios to insure cash flow/availability in the event of a downturn in the financial markets; thus preventing the need for the investor to sell-off other assets in their portfolio during the downturn in the financial markets.

Investment distribution management module 18 includes risk-period determining routine 28 that is configured to, based on the composite financial risk indicator 26 determine the number of future time periods 30 (e.g., the number of future years) for which investors 32, having a financial portfolio that is in distribution mode/phase, should have self-liquidating assets 34 (e.g., target maturity bonds or the like). The determination of number of future time periods 30 may also be referred to as a determination as to how many rungs should be added to the bond ladder. In specific examples of the invention, the number of future time periods 30 determined will take into account a predetermined number of minimal future time periods. For example, in one specific embodiment, three years is the predetermined number of minimal years for which an investor should have self-liquidating assets 34 in their financial portfolio, which will mature in the three ensuing calendar years to insure that the investor 32 has adequate cash flow in their financial portfolio in the near-term future (i.e., the next three years). In this regard, based on the composite financial risk indicator 26 indicating a certain level of increased or decreased risk, additional time periods may be added to the minimal number of time periods/years based on increased risk or time periods may be subtracted from the current number of time periods/years but may not fall below the minimal number of years. For example, if the minimal number of time periods/years is three years and the current number of time periods/years is four years (based on the composite risk indicator 26 previously indicating increased risk), the number of years may be decreased by one year (i.e., to three years) but may not be decreased by any more than one year.

Investment distribution module 18 also includes financial portfolio adjustment routine 36 that is configured to adjust the financial portfolios 38 of the investors 32 to provide for the self-liquidating assets 34 for each of the determined number of time periods 30. In this regard, the self-liquidating assets 34 may be purchased and added to an investor's portfolio or self-liquidating assets 34 may be sold-off and the proceeds used to purchase other assets for the investor's portfolio. It should be noted that the value of the self-liquidated assets 34 (e.g., the value of the self-liquidating asset at maturity) is approximately equal to the distribution need of each individual investor for the future time period offset by the anticipated/predicted income from the investor's portfolio over the future time period. It should be noted that the distribution need of each individual investor takes into account mandatory distributions dictated by the asset type (e.g., individual retirement accounts (IRAs) and the age of the investor (i.e., larger mandatory distribution amounts required as the investor's age increases).

Once the portfolio adjustments have been taken and the self-liquidating assets 34 have been provided for, the self-liquidating assets 34 will automatically liquidate at their respective future maturity dates to provide the investor the needed amount of cash flow.

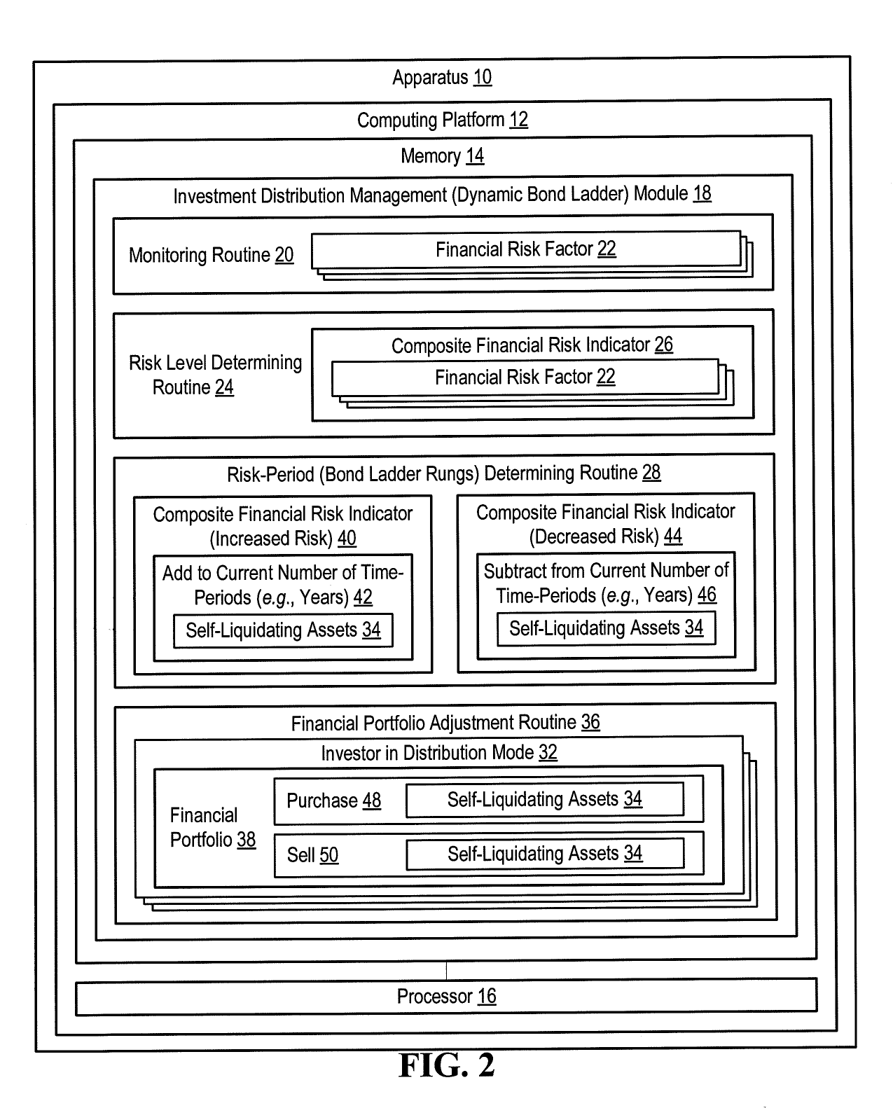

Referring to FIG. 2, shown is a more detailed block diagram of apparatus 10, according to embodiments of the present invention. The apparatus 10 is configured to manage distribution of a financial portfolio through implementation of an automated and dynamic risk-responsive bond ladder. In addition to providing greater detail, FIG. 2 highlights various alternate embodiments of the invention. The apparatus 10 may include one or more of any type of computing device. The present apparatus and methods can accordingly be performed on any form of one or more computing devices.

The apparatus 10 includes computing platform 12 that can receive and execute algorithms, such as routines, and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 2) that interfaces with any resident programs, such as investment distribution management module 18 and routines associated therewith or the like stored in the memory 14 of the apparatus 10.

Processor 16 includes various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications and exchanging data with other networked devices. For the disclosed aspects, processing subsystems of processor 14 may include any subsystem used in conjunction with investment distribution management module 18 and related algorithms, sub-algorithms, sub-modules thereof.

Computer platform 12 may additionally include communications module (not shown in FIG. 2) embodied in hardware, firmware, software, and combinations thereof, that enables communications among the various components of the apparatus 10, as well as between the other networked devices. Thus, communication module may include the requisite hardware, firmware, software and/or combinations thereof for establishing and maintaining a network communication connection.

As previously discussed in relation to FIG. 1, the memory 14 of apparatus 10 stores investment distribution management (i.e., dynamic bond ladder) module 18 that is configured managing distribution of a financial portfolio through implementation of an automated and dynamic risk-responsive bond ladder, in accordance with embodiments of the present invention. Investment distribution management module 18 (or another module working in concert with investment distribution management module 18) implements a financial risk monitoring routine 20 that is configured to continuously monitor a plurality of financial risk factors 22 (i.e., economic indicators and predictors). In specific embodiments of the invention, upwards of 300 different risk factors 22, which serve as lead indicators of financial risk. The risk factors may include generally include, but are not limited to, risk factors that indicate economic inflation/deflation, economic (actual gross domestic product (GDP) expansion/contraction, credit expansion/contraction, economic volatility, overall (non-stock or investment specific) market risk factors, pure financial risk models, monetary policies, and the like. Specific examples of the risk factors may include, but are not limited to, composite financial stress index, composite lead economic indicators, volatility in interest rate markets, volatility in currency markets, volatility in default credit swaps, treasury yield curve rates, high yield bond credit spreads, and the like.

As previously discussed in relation to FIG. 1, the investment distribution management module (or another module working in concert with investment distribution management module 18) implements risk level determining routine 24 that is configured to determine a dynamic and cumulative financial risk indicator 26 based on the financial risk factors 22. The financial risk indicator 26 provides an indication of the risk (i.e., stress) present and/or anticipated in financial markets. In specific embodiments of the invention, the cumulative financial risk indicator 26 may indicate a level of financial risk (i.e., a potential for a downturn in the financial markets or some other factor that may devalue the investor's portfolio), such as one of a low level of risk, a medium level of risk or a high level of risk. In such embodiments of the invention if the financial risk indicator 26 indicates a high level of risk, or in some embodiments a medium or high level of risk, a determination may be made to add one or more future time periods/years to the number of time periods/years in which the investor should have self-liquidating assets in their portfolio (i.e., add rungs to the bond ladder). In other specific embodiments of the invention, the financial risk indicator 26 may be configured to have individual components, such as, but not limited to, a domestic equity risk component, an international equity risk component, a bond risk component, a real asset (e.g., real estate, commodities, and the like) component. In such embodiments the financial risk indicator 26 may be such that if only one or two components indicate high risk, a subsequent determination may be made to add one or two future time periods/years to the bond ladder (i.e., the number of time periods/years in which the investor should have self-liquidating assets in their portfolio). However, in instances in which all of the components that make up the financial risk indicator 26 indicate high risk, a subsequent determination may be made to add a maximum number of future time periods/years to the bond ladder, for example, increase the number of years to ten years, where ten is the predetermined maximum number of years.

The investment distribution module 18 also includes the risk period determining routine 28 that is configured to determine, based on the composite financial risk indicator 40, the number of future time periods/years that an investor, in distribution mode, should have self-liquidating assets 34 (e.g., target maturity bonds or the like) in their financial portfolio. It should be noted that in most instances determination of the number of time periods/years for which an investor should have self-liquidating assets is typically conducted for most, if not all, of an investment advisors investors/clients. In this regard, an investor/client may choose to opt-in or opt-out of the automated and dynamic bond ladder program, in which self-liquidating assets are added to or removed from an investor's portfolio, automatically, depending upon the level of risk apparent in the financial markets.

In specific embodiments of the invention, in which the composite financial risk indicator indicates increased risk 40, additional time periods/years are added 42 to the bond ladder (i.e., time periods/years in which investor should have self-liquidating assets 34 in their financial portfolio). In certain instances risk level thresholds may be set, such that, if the level of risk rises above the predetermined threshold, one additional time period/year is added to the current number of time periods/year. It should be noted that in such embodiments of the invention the threshold may be associated with a certain number of risk model components indicating a predetermined level of risk or an overall financial risk indicator that takes into account all of the components. In practice, future time periods/years may be added to the bond ladder, one at a time, in relatively rapid succession (e.g., over a few week period) based on reactions in the financial markets (i.e., risk indicators causing rapid movement of markets). In other instances, the level of risk may rise to such a high level in a short period of time, which may trigger addition of more than one, and in some instances up to a maximum, number of future time periods/years. For example, if all models/components rapidly indicate a high level of risk, the number of time periods/years added to the bond chain may be a maximum configured number of time periods/years (e.g., ten years).

In other embodiments of the invention, in which the composite financial risk indicates decreased risk 44, time periods/years are subtracted 46 from the bind ladder (i.e., time periods/years in which investor should have self-liquidating assets 34 in their financial portfolio). As such, the automated and dynamic risk-responsive bond ladder of the present invention provides overall liquidity management, in that, not only are time periods/years add based on increased risk but, also, time periods/years are eliminated based on a decreased risk. Similar to adding time periods/years, in certain embodiments if the invention, risk level thresholds may be set, such that, if the level of risk fall below the predetermined threshold, one additional time period/year is subtracted from the current number of time periods/year. As previously noted, the dynamic bond ladder may be configured such that a predetermined number of minimal time periods/years, for which the investor should have self-liquidating assets is constantly maintained (e.g., three years) and, thus, the number of time periods/years may not be subtracted from current number of time periods/years if the result would fall below the minimal number of time periods/years. Additionally, in such instances in which a minimal number of years is implemented, it is presumed that additional years will have been previously added to the minimal number of years (based on increased risk) in order for years to be subsequently subtracted from the bond ladder (based on decreased risk).

Investment distribution module 18 also includes financial portfolio adjustment routine 36 that is configured to adjust the financial portfolios 38 of the investors 32 to provide for the self-liquidating assets 34 for each of the determined number of time periods 30. In this regard, the self-liquidating assets 34 may be purchased 48 and added to an investor's portfolio. Funds used to purchase the self-liquidating assets may come from assets having the highest current risk, for example, equity, bonds, cash, real estate or the like. In other embodiments, self-liquidating assets 34 may be sold 50 and the proceeds used to purchase other more attractive (i.e., less risk/more potential for growth) assets for the investor's portfolio. It should be noted that the module may be configures such that the determination of adding or subtracting time periods/years from the bond ladder is the triggering event for automatically adjusting the financial portfolios (i.e., automatically purchasing or selling the self-liquidating assets).

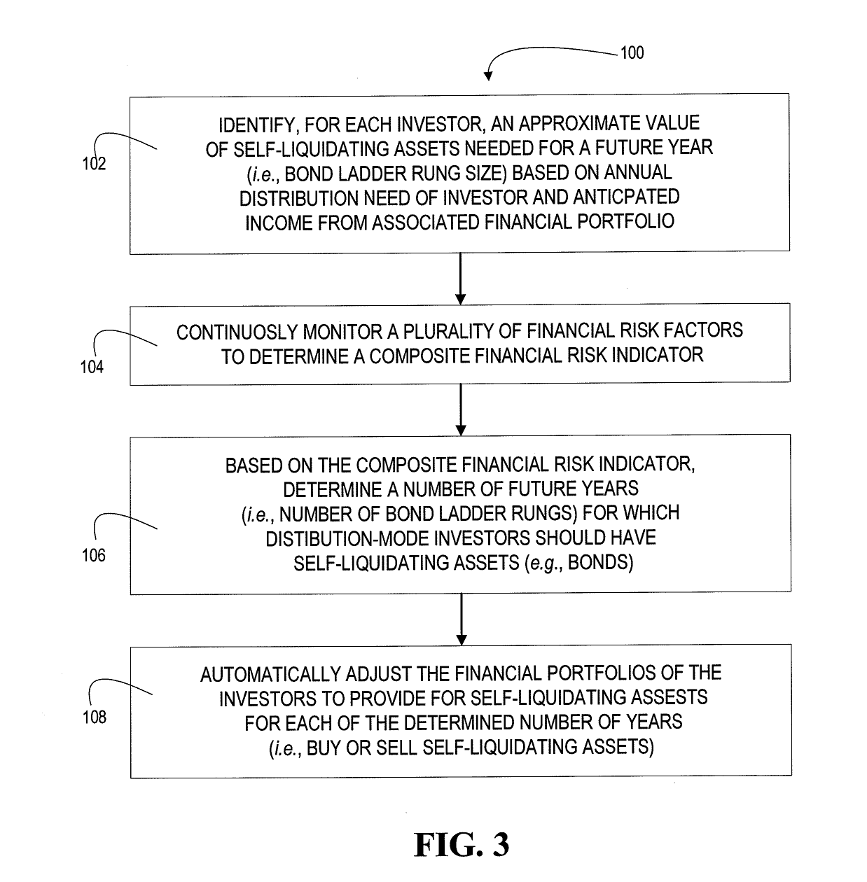

Referring to FIG. 3, a flow diagram is presented of a method 100 for managing distribution of financial portfolios through use of an automated and dynamic risk-responsive bond ladder, in accordance with embodiments of the present invention. At Event 102, for each investor that is in the distribution phase of their financial portfolio and is or may be participating in the bond ladder, an approximate value of the self-liquidating assets needed for a future time period/year is identified. This is also referred to herein as sizing the rung of the bond ladder and, as such, each individual investor will have an investor-specific rung size. The value of the self-liquidating assets needed is based on the annual distribution needs of the investor offset by the anticipated income from the investor's financial portfolio. In specific embodiments of the invention, input is required of the investor to assess annual distribution needs. The annual distribution needs may be defined as a percentage of the overall financial portfolio. The investment advisor may provide the investor a menu of distribution options, for example, options ranging from 4.0% to 7.0%. It should be noted that certain non-taxable assets, such as Individual Retirement Accounts (IRAs) have required minimum distributions that become larger as the investor ages, such mandatory distributions must be taken into account when assessing the investor's distribution needs. The investor advisor will provide the anticipated income from the investor's financial portfolio based on the investor's investment approach (conservative, moderately conservative, moderate, moderate aggressive, aggressive or the like) and/or the current assets of the investor's portfolio. In addition, the investment advisor may net down the anticipated gross investment income to account for fees, taxes and uncertainty, so as to insure that the cash generated from the self-liquidating assets sufficiently provides for the net cash needed by the investor.

At Event 104, a plurality of financial risk factors are continuously monitored to determine a composite financial risk indicator. The risk factors are continuously monitored and determination of the composite financial risk indicators are conducted constantly, for example, each business day to insure that changes in risk are identified as soon as possible. As previous noted, in specific embodiments the risk factors may be upwards of three hundred risk factors that take into account economic fundamentals, pure financial risk models and the like that may be external or internal to the investment advisors (i.e., bond ladder provider). The composite financial risk indicator may include various risk models and/or components that take into account different financial risk, such as domestic equity risk, international equity risk, bond risk, real asset (real estate, commodities, or the like) risk and so on.

At Event 106, based on the composite financial risk indicator indicating a requisite level of increase or decrease in financial risk, a number of future time periods/years are added or subtracted from the bond ladder (i.e., the number of future time periods/years for which an investor, whose portfolio is in distribution mode/phase, should have adequate self-liquidating assets (e.g., target maturity bonds or the like) to insure proper cash flow during the future time periods/years). In many instances the number of time periods/years added to or subtracted from the bond ladder will go up incrementally (i.e., one year added or one year subtracted from the bond ladder) based on an incremental increase or decrease in the composite financial risk indicator. However, in other instances the rapid and sharp increase or decrease in the composite financial risk indicator may prompt more than one time period/year to added to the bond ladder (e.g., if all economic indicators show high risk the bond ladder may add the maximum permissible amount of time periods/years).

At Event 108, the financial portfolios of the investors are automatically adjusted to provide the self-liquidating assets for each of the determined number of time periods/years. As such, as a result of years being added to the bond ladder, self-liquidating assets are purchased for the portfolio by re-allocating funds received from the sale of assets in the portfolio that are at the highest risk. As discussed above, the value of the self-liquidating assets that are purchased for any given future year are approximately equivalent to the annual distribution need/requirement of the individual investor offset by the anticipated income produced by the investor's financial portfolio. As a result of years being subtracted from the bond ladder, self-liquidating assets that were previously added and are to more in the time periods/years being subtracted are sold and the proceeds re-invested in other more attractive assets.

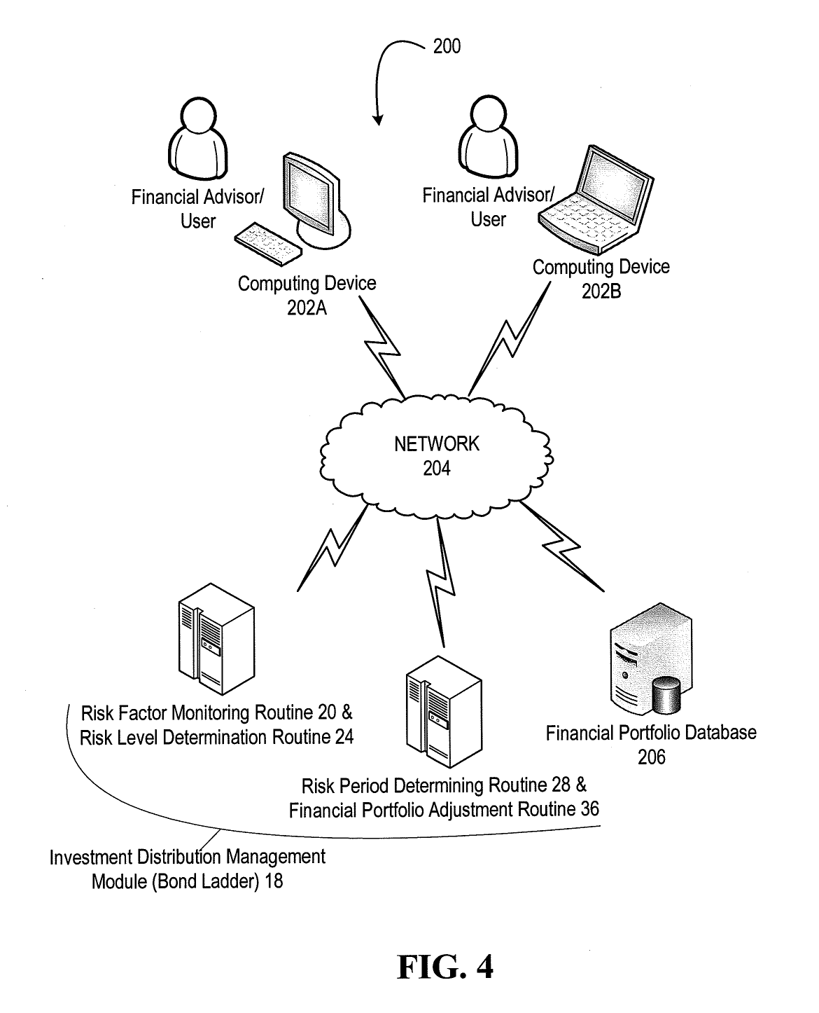

Referring to FIG. 4 a schematic diagram is presented of an operating environment/system 200 for managing the distribution of investment portfolios using an automated and dynamic risk-responsive bond ladder, in accordance with embodiments of the present invention. The operating environment 700 includes an investment distribution module 18. In addition, one or more investment advisor/users, each having a user computing device 202, such as a PC 202A, laptop 202B, mobile phone, tablet, television, mobile device, or the like, may be in communication with the investment distribution module 18 via a network 204, such as the Internet, wide area network, local area network, Bluetooth network, near field network, or any other form of contact or contactless network. The investment distribution module 18 which includes a server or other computing device for implementing the risk factor determining routine 20 and risk level determining routine 24 is in communication another server/computing device for implementing the risk period (bond ladder rung) determining routine and financial portfolio adjustment routine 36. It should be noted that while the functions described are executed on two separate servers/computing devices more or less servers/computing devices may be implemented to execute the functionality of the investment distribution management (i.e., dynamic bond ladder) module 18 herein described. The investment distribution management (i.e., dynamic bond ladder) module 18 is additionally in communication with financial portfolio database 206 via the network 710. In addition, investment distribution management 18 may be in communication with one or more network-based brokers (not shown in FIG. 4) for the purpose of executing the purchases and sales of self-liquidating assets.

Thus, present embodiments herein disclosed provide for automatically determining the number of years, or other periods of time, for which an investor in the distribution phase of investing, should have self-liquidating assets (e.g., target maturity bond investments) in their portfolio for the purpose of accommodating the investor's cash flow needs to during period of high market volatility. The number of years is determined by monitoring financial risk factors to render a cumulative financial risk indicator which incorporates market value, market risks and technical thresholds. In response to determining the number of years adjustments to the portfolio are made to provide for self-liquidating assets during the determining number of years (i.e., self-liquidating assets are purchased if years are added or self-liquidating assets are sold and proceeds re-invested if years are subtracted). As such, the investor is insured of having an adequate cash supply to accommodate cash flow needs during periods of market downturn/high volatility and protected from having to liquidate shares in the investment portfolio during such periods.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. An apparatus for managing the distribution of investment portfolios, the apparatus comprising:
a computing platform including a memory and at least one processor in communication with the memory;
an investment distribution management module stored in the memory, executable by the processor and configured to:
continuously monitor a plurality of financial risk factors to determine a composite financial risk indicator;
based on the composite financial risk indicator, determine a number of future time periods for which investors having a financial portfolio in distribution mode should have self-liquidating assets; and
adjust the financial portfolios of the investors to provide for self-liquidating assets for each of the determined number of future time periods, wherein the self-liquidating assets provided for in a future time period are approximately equal in value to a distribution need of each individual investor for the future time period minus an anticipated income from an associated financial portfolio over the future time period.

2. The apparatus of claim 1, wherein the investment distribution management module is further configured to, based on the composite financial risk indicator indicating increased financial risk, add one or more future time periods to a current number of future time periods for which the investors should have self-liquidating assets.

3. The apparatus of claim 2, wherein the investment distribution management module is further configured to, in response to adding the one or more future time periods, automatically adjust the financial portfolios of the investors by using financial portfolio investment funds to purchase self-liquidating assets for each of the one or more future time periods.

4. The apparatus of claim 1, wherein the investment distribution management module is further configured to, based on the composite financial risk indicator indicating decreased financial risk, subtract one or more future time periods from a current number of future time periods for which the investors should have self-liquidating assets.

5. The apparatus of claim 4, wherein the investment distribution management module is further configured to, in response to subtracting the one or more future time periods, automatically adjust the financial portfolios of the investors by selling-off self-liquidating assets previously purchased for the one or more future time periods.

6. The apparatus of claim 1, wherein the investment distribution management module is further configured to:
based on the composite financial risk indicator, determine the number of future time periods, wherein the future time period is a future calendar year; and
adjust the financial portfolios of the investors to provide for self-liquidating assets for each of the determined number of future calendar years, wherein the self-liquidating assets provided for in a future calendar year are approximately equal in value to a distribution need of each individual investor for the future calendar year minus an anticipated income from an associated financial portfolio over the future calendar year.

7. The apparatus of claim 1, wherein the investment distribution management module is further configured to continuously monitor the plurality of financial risk factors including a plurality of a treasury yield curve, credit expansion and contraction, inflation profile, government monetary policy, gross domestic product expansion and contraction, composite financial stress index, volatility in interest rate markets, volatility in currency markets, changes in volume of credit default swaps and high yield bond credit spreads.

8. A method for managing financial portfolio distribution, the method comprising:
continuously monitoring, by a computing device processor, a plurality of financial risk factors to determine a composite financial risk indicator;
based on the composite financial risk indicator, determining, by a computing device processor, a number of future calendar years for which investors having a financial portfolio in distribution mode should have self-liquidating assets; and
adjusting the financial portfolios of the investors to provide for self-liquidating assets for each of the determined number of future calendar years, wherein the self-liquidating assets provided for in a future calendar year are approximately equal in value to an annual distribution need of each individual investor minus an anticipated income from an associated financial portfolio during the future calendar year.

9. The method of claim 8, wherein determining the number of future calendar years further comprises, based on the composite financial risk indicator indicating increased financial risk, adding one or more future calendar years to a current number of future calendar years for which the investors should have self-liquidating assets.

10. The method of claim 9, wherein adjusting the financial portfolios further comprises, in response to adding the one or more future calendar years, automatically adjusting the financial portfolios of the investors by using financial portfolio investment funds to purchase self-liquidating assets for each of the one or more future calendar years.

11. The method of claim 8, wherein determining the number of future calendar years further comprises, based on the composite financial risk indicator indicating decreased financial risk, subtracting one or more future calendar years from a current number of future calendar years for which the investors should have self-liquidating assets.

12. The method of claim 11, wherein adjusting the financial portfolios further comprises, in response to subtracting the one or more future time periods, automatically adjusting the financial portfolios of the investors by selling-off self-liquidating assets previously purchased for the one or more future time periods.

13. The method of claim 8, further comprising determining, for each investor, an approximate value of the self-liquidating assets needed for a future calendar year based on the annual distribution need of each individual investor and the anticipated income from an associated financial portfolio during the future calendar year.

14. The method of claim 13, wherein determining, for each investor, an approximate value of the self-liquidating assets needed for a future calendar year based on the annual distribution need of each individual investor, wherein the annual distribution need of each investor takes into account mandatory distributions from predetermined accounts based on investor age.

15. A computer program product comprising:
a non-transitory computer-readable medium comprising:
a first set of codes for causing a computer to continuously monitor a plurality of financial risk factors to determine a composite financial risk indicator;
a second set of codes for causing a computer to, based on the composite financial risk indicator, determine a number of future time periods for which investors having a financial portfolio in distribution mode should have self-liquidating assets; and
a third set of codes for causing a computer to adjust the financial portfolios of the investors to provide for self-liquidating assets for each of the determined number of future time periods, wherein the self-liquidating assets provided for in a future time period are approximately equal in value to a distribution need of each individual investor for the future time period minus an anticipated income from an associated financial portfolio over the future time period.

16. The computer program product of claim 15, wherein the second set of codes is further configured to cause the computer to, based on the composite financial risk indicator indicating increased financial risk, add one or more future time periods to a current number of future time periods for which the investors should have self-liquidating assets.

17. The computer program product of claim 16, wherein the third set of codes is further configured to cause the computer to, in response to adding the one or more future time periods, automatically adjust the financial portfolios of the investors by using financial portfolio investment funds to purchase self-liquidating assets for each of the one or more future time periods.

18. The computer program product of claim 15, wherein the second set of codes is further configured to cause the computer to, based on the composite financial risk indicator indicating decreased financial risk, subtract one or more future time periods from a current number of future time periods for which the investors should have self-liquidating assets.

19. The computer program product of claim 18, wherein the third set of codes is further configured to cause the computer to, in response to subtracting the one or more future time periods, automatically adjust the financial portfolios of the investors by selling-off self-liquidating assets previously purchased for the one or more future time periods.

20. The computer program product of claim 15, wherein the second set of codes is further configured to cause the computer to, based on the composite financial risk indicator, determine the number of future time periods, wherein the future time period is a future calendar year and wherein the third set of codes is further configured to cause the computer to adjust the financial portfolios of the investors to provide for self-liquidating assets for each of the determined number of future calendar years, wherein the self-liquidating assets provided for in a future calendar year are approximately equal in value to a distribution need of each individual investor for the future calendar year minus an anticipated income from an associated financial portfolio over the future calendar year.
